(19) United States
(12) Patent Application Publication
(10) Pub. No.: US 2020/0363890 A1
(43) Pub. Date: Nov. 19, 2020

(54) DISPLAY SUBSTRATE AND MANUFACTURING METHOD THEREFOR, AND TOUCH DISPLAY DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Dong WANG, Beijing (CN); Yue LI, Beijing (CN); Wang GUO, Beijing (CN); Mingyang LV, Beijing (CN); Yu ZHAO, Beijing (CN); Yanchen LI, Beijing (CN); Hailong WANG, Beijing (CN); Hongbo FENG, Beijing (CN); Jinyu LI, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/640,222

(22) PCT Filed: Apr. 24, 2019
(86) PCT No.: PCT/CN2019/084113

§ 371 Date: Feb. 19, 2020

(30) Foreign Application Priority Data
Apr. 28, 2018 (CN) 201810402968.5

(51) Int. Cl. G06F 3/041; G06F 3/044

(52) U.S. Cl. CPC G06F 3/0412; G02F 1/136286; G06F 3/0443

(57) ABSTRACT

A display substrate, a manufacturing method thereof and a touch display device are disclosed. The display substrate includes a plurality of pixel units arranged in an array, every column of pixel units is provided with one corresponding first data line, every adjacent three columns of pixel units constitute one pixel unit group, and one second data line and one touch signal line are provided between every adjacent two pixel unit groups; between every adjacent two pixel unit groups, the second data line and the first data line are located at two sides of the touch signal line, respectively; and for the pixel unit adjacent to the second data line, a coupling capacitance between the pixel unit and the first data line adjacent to the pixel unit is as same as a coupling capacitance between the pixel unit and the second data line adjacent to the pixel unit.

### TECHNICAL FIELD

Embodiments of the present disclosure relate to a display substrate, a manufacturing method thereof, and a touch display device.

### BACKGROUND

Touch and Display Driver Integration (TDDI) technology is to integrate a display function and a touch function onto an integrated module. In designing, not only the display function but also the touch function is required to be realized.

At present, a TDDI product embeds a touch panel into a pixel unit, realizes the touch function by sharing a conductive layer in a time-sharing mode, and divides the conductive layer in a display region of a display screen into a plurality of touch modules which are connected with touch signal lines arranged in a same layer with data lines.

### SUMMARY

At least one embodiment of the present disclosure provides a display substrate, a manufacturing method thereof and a touch display device, which can extend service lives of the touch display panel and the touch display device.

On one aspect, the embodiment of the present disclosure provides a display substrate, including a plurality of pixel units arranged in an array, wherein every column of pixel units is provided with one corresponding first data line, every adjacent three columns of pixel units constitute one pixel unit group, and one second data line and one touch signal line are provided between every adjacent two pixel unit groups; between every adjacent two pixel unit groups, the second data line and the first data line are located at two sides of the touch signal line, respectively; and for the pixel unit adjacent to the second data line, a coupling capacitance between the pixel unit and the first data line adjacent to the pixel unit is as same as a coupling capacitance between the pixel unit and the second data line adjacent to the pixel unit.

Optionally, the second data line and the first data line located at two sides of the touch signal line respectively are arranged symmetrically about the touch signal line.

Optionally, a line width of the first data line is as same as a line width of the second data line.

Optionally, the first data line, the second data line and the touch signal line are arranged at a same layer.

Optionally, the display substrate is a self-inductance capacitive touch display substrate, and the self-inductance capacitive touch display substrate further includes: a touch electrode layer spaced apart from a layer where the first data line, the second data line and the touch signal line are located; and a passivation layer located between the touch electrode layer and the layer where the first data line, the second data line and the touch signal line are located, wherein the touch electrode layer includes a plurality of touch electrode units arranged in an array, and the touch electrode units are connected with the touch signal lines in one-to-one correspondence through via holes in the passivation layer.

On another aspect, the embodiment of the present disclosure further provides a touch display device, including any display substrate described above.

Optionally, the display device provided by the embodiment of the present disclosure further includes a cover plate cell-assembled with the display substrate, a side of the cover plate close to the display substrate is provided with a black matrix, the black matrix is configured to cover the first data line, the second data line and the touch signal line.

On yet another aspect, the embodiment of the present disclosure further provides a manufacturing method of a display substrate, including: forming a plurality of pixel units arranged in an array; forming one corresponding first data line for every column of pixel units; and constituting one pixel unit group by every adjacent three columns of pixel units, and forming one second data line and one touch signal line between every adjacent two pixel unit groups so that: the second data line and the first data line are located at two sides of the touch signal line respectively and are arranged symmetrically about the touch signal line; and for the pixel unit adjacent to the second data line, a coupling capacitance between the pixel unit and the first data line adjacent to the pixel unit is as same as a coupling capacitance between the pixel unit and the second data line adjacent to the pixel unit.

Optionally, after forming the first data line, the touch signal line and the second data line, the manufacturing method further includes: forming a passivation layer on the first data line, the touch signal line and the second data line; forming via holes in the passivation layer; forming a touch electrode layer on the passivation layer in which the via holes are formed; and forming touch electrode units by the touch electrode layer and connecting the touch electrode units with the touch signal lines in one-to-one correspondence through the via holes.

Optionally, forming the via holes in the passivation layer by etching.

Optionally, forming the touch electrode layer on the passivation layer through depositing.

Optionally, forming the touch electrode units by etching the touch electrode layer.

### BRIEF DESCRIPTION OF THE DRAWINGS

In order to clearly illustrate the technical solutions of the embodiments of the disclosure, the drawings necessary for the explanation of the embodiments or the prior art will be briefly described in the following. It is obvious that the described drawings are only related to some embodiments of the disclosure, from which other figures may be derived by those ordinary skilled in the art without any creative labor.

FIG. 1 is a structural diagram illustrating a display substrate;

FIG. 2 is a structural diagram illustrating a display substrate provided by an embodiment of the present disclosure;

FIG. 3 is a structural diagram illustrating a display substrate provided by another embodiment of the present disclosure;

FIG. 4 is a structural diagram illustrating a display device provided by an embodiment of the present disclosure; and

FIG. 5 is a flow chart illustrating a manufacturing method of a display substrate provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms “comprise” or “include” are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

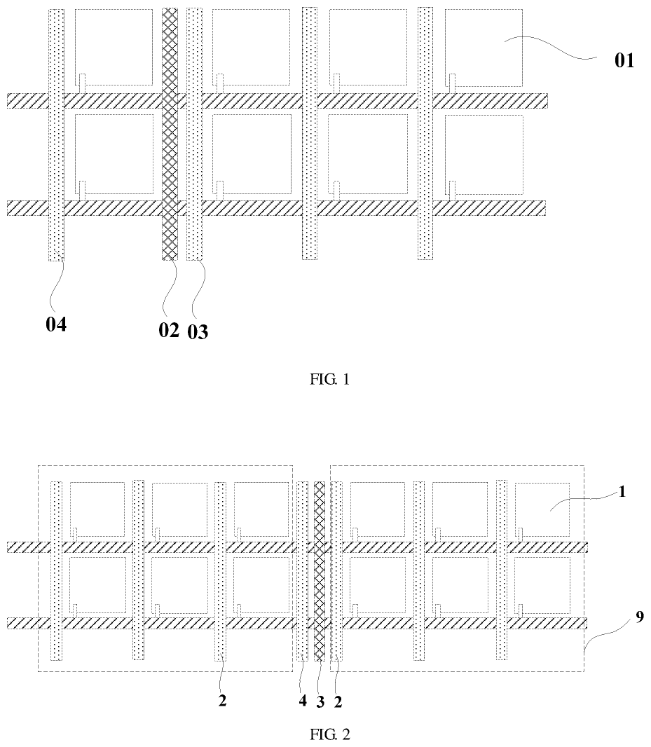

FIG. 1 is a structural diagram illustrating a display substrate based on TDDI technology. As illustrated in FIG. 1, the display substrate includes a plurality of pixel units 01 arranged in an array; every three columns of pixel units 01 are provided with one corresponding touch signal line 02; and the touch signal line 02 is provided between one column of pixel units 01 and a data line 03 adjacent to this column of pixel units 01. Such arrangement may result in that a distance between this column of pixel units 01 and the data line 03 adjacent thereto is not as same as a distance between this column of pixel units 01 and a data line 04 connected thereto, which leads to that a coupling capacitance between the connected data line 04 and a pixel electrode of the pixel unit 01 is not as same as a coupling capacitance between the adjacent data line 03 and the pixel electrode. For a product utilizing a column inversion mode, although data lines located at two sides of the pixel unit 01 have opposite polarities, coupling effects of these data lines acting on the pixel electrode cannot be counteracted, thereby resulting in considerable risks of crosstalk.

FIG. 2 illustrates a display substrate provided by an embodiment of the present disclosure, including a plurality of pixel units 1 arranged in an array. Every column of pixel units 1 is provided with one corresponding first data line 2; every adjacent three columns of pixel units 1 constitute one pixel unit group 9, and between every adjacent two pixel unit groups 9, one second dada line 4 and one touch signal line 3 are provided; between every adjacent two pixel units groups 9, the second data line 4 and the first data line 2 are located at two sides of the touch signal line 3, respectively; and for the pixel unit 1 adjacent to the second data line 4, a coupling capacitance between the pixel unit 1 and the first data line 2 adjacent thereto is as same as a coupling capacitance between the pixel unit 1 and the second data line 4 adjacent thereto.

The display substrate provided by the embodiment of the present disclosure is provided with the second data line 4 which is symmetrical with the first data line 2 corresponding to the pixel unit 1 about the touch signal line 3. The coupling effects generated by the data lines located at two sides of the pixel electrode may be calculated by a formula of: Δ V=[cpd1/(cgs+cst+clc+cpd)] (Vdata1−Vdata1*)+[cpd2/(cgs+cst+clc+cpd)] (Vdata2−Vdata2*), wherein cpd1 and cpd2 represent a coupling capacitance of the first data line with respect to the pixel electrode and a coupling capacitance of the second data line with respect to the pixel electrode, respectively; Vdata1, Vdata1* and Vdata2, Vdata2* represent voltage changes of the first data line and the second data line, respectively; cgs represents a capacitance between a gate electrode and a source electrode of a thin film transistor; cst represents a capacitance between a conductive layer and a common electrode when a passivation layer is used as an electrified body; clc represents the capacitance between the conductive layer and the common electrode when a liquid crystal is used as the electrified body; and cpd represents a coupling capacitance between the data line and the conductive layer.

On the basis of the arrangement of the first data line 2, the second data line 4 and the touch signal line 3 in the display substrate provided by the embodiment of the present disclosure and on the basis of the above-described computational formula, given that a coupling capacitance between the second data line 4 and the pixel electrode of the pixel unit 1 adjacent to the second data line 4 is C2, and a coupling capacitance between the first data line 2 corresponding to the pixel unit 1 and the pixel electrode of the pixel unit 1 is C1 in the present embodiment, then C1 is as same as C2, which can significantly reduce the risks of crosstalk resulted by the coupling capacitance, thereby extending service lives of the display substrate and the touch display device including the display substrate.

As illustrated in FIG. 2, in the embodiment of the present disclosure, optionally, the second data line 4 and the first data line 2 located at two sides of the touch signal lien 3 respectively are arranged symmetrically about the touch signal line 3. Such arrangement allows the coupling capacitance between the second data line 4 and the pixel electrode of the pixel unit 1 adjacent to the second data line 4 to be as same as the coupling capacitance between the first data line 2 corresponding to the pixel unit 1 and the pixel electrode of the pixel unit 1, and also simplifies the manufacturing process at the same time, thereby improving the processing efficiency of the display substrate.

In the embodiment of the present disclosure, optionally, a line width of the first data line is as same as a line width of the second data line, so that the coupling capacitances of the second data line and the first data line with respect to the pixel electrode of the pixel unit between the second data line and the first data line can be as same as each other, and the manufacturing process of the display substrate can be further simplified at the same time.

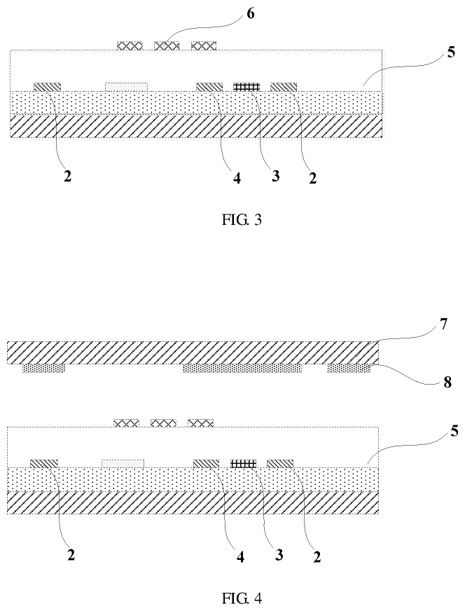

As illustrated in FIG. 3, in the embodiment of the present disclosure, optionally, the first data line 2, the second data line 4 and the touch signal line 3 are disposed in a same layer. In this way, the number of the film layer in the display substrate can be effectively reduced, which facilitates realizing a thinner design of the display device.

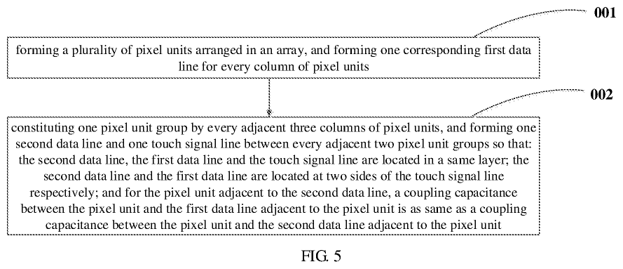

As illustrated in FIG. 3 and FIG. 4, in the embodiment of the present disclosure, optionally, the display substrate is a self-inductance capacitive touch display substrate, and the self-inductance capacitive touch display substrate further includes: a touch electrode layer spaced apart from a layer where the first data line 2, the second data line 4 and the touch signal line 3 are located; and a passivation layer located between the touch electrode layer and the layer where the first data line 2, the second data line 4 and the touch signal line 3 are located. The touch electrode layer includes a plurality of touch electrode units 6 arranged in an array, and the touch electrode units 6 are connected with the touch signal lines 3 in one-to-one correspondence through via holes (not illustrated) in the passivation layer 5.

As illustrated in FIG. 4, based on the same inventive concept, the embodiment of the present disclosure further provides a touch display device including the display substrate provided by any of the foregoing embodiments.

In the display device provided by the embodiment of the present disclosure, coupling capacitances of the first data line 2 and the second data line 4 located at two sides of the pixel unit with respect to the pixel electrode of the pixel unit have the same values, so that the risk of crosstalk resulted by the coupling capacitance is relatively low and the service life is longer.

As illustrated in FIG. 4, in the embodiment of the present disclosure, optionally, the touch display device further includes a cover plate 7 cell-assembled with the display substrate, a side of the cover plate 7 close to the display substrate is provided with a black matrix 8, the black matrix 8 is configured to cover the first data line 2, the second data line 4 and the touch signal line 3.

As illustrated in FIG. 5, based on the same inventive concept, the embodiment of the present disclosure further provides a manufacturing method of a display substrate, including:

Step S001, forming a plurality of pixel units arranged in an array, and forming one corresponding first data line for every column of pixel units;

Step S002, constituting one pixel unit group by every adjacent three columns of pixel units, and forming one second data line and one touch signal line between every adjacent two pixel unit groups so that: the second data line, the first data line and the touch signal line are located in a same layer; the second data line and the first data line are located at two sides of the touch signal line respectively and are arranged symmetrically about the touch signal line; and for the pixel unit adjacent to the second data line, a coupling capacitance between the pixel unit and the first data line adjacent to the pixel unit is as same as a coupling capacitance between the pixel unit and the second data line adjacent to the pixel unit.

In the display substrate manufactured by using the manufacturing method provided by the embodiment of the present disclosure, the coupling capacitance between the second data line and the pixel electrode of the pixel unit adjacent to the second data line is as same as the coupling capacitance between the first data line corresponding to the pixel unit and the pixel electrode of the pixel unit, so as to significantly reduce the risk of crosstalk resulted by the coupling capacitance, and hence to extend the service life of the touch display device including the display substrate.

In the embodiment of the present disclosure, optionally, after forming the first data line, the touch signal line and the second data line, the manufacturing method further includes:

forming a passivation layer on the first data line, the touch signal line and the second data line;

forming via holes in the passivation layer;

forming a touch electrode layer on the passivation layer in which the via holes are formed; and

forming touch electrode units by etching the touch electrode layer, and connecting the touch electrode units with the touch signal lines in one-to-one correspondence through the via holes.

The type of the touch display device will not be particularly limited in the embodiment of the present disclosure. For example, the touch display device may be a liquid crystal touch display device, an electrophoresis touch display device, an organic light-emitting diode touch display device or the like.

What are described above is the embodiments of the disclosure only and not limitative to the scope of the disclosure; any of those skilled in related arts can easily conceive variations and substitutions in the technical scopes disclosed by the disclosure, which should be encompassed in protection scopes of the disclosure. Therefore, the scopes of the disclosure should be defined in the appended claims.

The present application claims priority of Chinese Patent Application No. 201810402968.5 filed on Apr. 28, 2018, the present disclosure of which is incorporated herein by reference in its entirety as part of the present application.

1. A display substrate, comprising a plurality of pixel units arranged in an array, wherein
every column of pixel units is provided with one corresponding first data line, every adjacent three columns of pixel units constitute one pixel unit group, and one second data line and one touch signal line are provided between every adjacent two pixel unit groups;
between every adjacent two pixel unit groups, the second data line and the first data line are located at two sides of the touch signal line, respectively; and
for the pixel unit adjacent to the second data line, a coupling capacitance between the pixel unit and the first data line adjacent to the pixel unit is as same as a coupling capacitance between the pixel unit and the second data line adjacent to the pixel unit.

2. The display substrate according to claim 1, wherein the second data line and the first data line located at two sides of the touch signal line respectively are arranged symmetrically about the touch signal line.

3. The display substrate according to claim 1, wherein a line width of the first data line is as same as a line width of the second data line.

4. The display substrate according to claim 1, wherein the first data line, the second data line and the touch signal line are arranged at a same layer.

5. The display substrate according to claim 4, wherein the display substrate is a self-inductance capacitive touch display substrate, and the self-inductance capacitive touch display substrate further comprises: a touch electrode layer spaced apart from a layer where the first data line, the second data line and the touch signal line are located; and a passivation layer located between the touch electrode layer and the layer where the first data line, the second data line and the touch signal line are located, wherein
the touch electrode layer comprises a plurality of touch electrode units arranged in an array, and the touch electrode units are connected with the touch signal lines in one-to-one correspondence through via holes in the passivation layer.

6. A touch display device, comprising the display substrate according to claim 1.

7. The touch display device according to claim 6, further comprising a cover plate cell-assembled with the display substrate,
a side of the cover plate close to the display substrate is provided with a black matrix, the black matrix is configured to cover the first data line, the second data line and the touch signal line.

8. A manufacturing method of a display substrate, comprising:
forming a plurality of pixel units arranged in an array;
forming one corresponding first data line for every column of pixel units; and
constituting one pixel unit group by every adjacent three columns of pixel units, and forming one second data line and one touch signal line between every adjacent two pixel unit groups so that: the second data line and the first data line are located at two sides of the touch signal line respectively and are arranged symmetrically about the touch signal line; and for the pixel unit adjacent to the second data line, a coupling capacitance between the pixel unit and the first data line adjacent to the pixel unit is as same as a coupling capacitance between the pixel unit and the second data line adjacent to the pixel unit.

9. The manufacturing method according to claim 8, wherein after forming the first data line, the touch signal line and the second data line, the manufacturing method further comprises:
forming a passivation layer on the first data line, the touch signal line and the second data line;
forming via holes in the passivation layer;
forming a touch electrode layer on the passivation layer in which the via holes are formed; and
forming touch electrode units by the touch electrode layer and connecting the touch electrode units with the touch signal lines in one-to-one correspondence through the via holes.

10. The manufacturing method according to claim 9, wherein forming the via holes in the passivation layer by etching.

11. The manufacturing method according to claim 9, wherein forming the touch electrode layer on the passivation layer through depositing.

12. The manufacturing method according to claim 9, wherein forming the touch electrode units by etching the touch electrode layer.

13. The touch display device according to claim 6, wherein the second data line and the first data line located at two sides of the touch signal line respectively are arranged symmetrically about the touch signal line.

14. The touch display device according to claim 6, wherein a line width of the first data line is as same as a line width of the second data line.

15. The touch display device according to claim 6, wherein the first data line, the second data line and the touch signal line are arranged at a same layer.

16. The touch display device according to claim 15, wherein the display substrate is a self-inductance capacitive touch display substrate, and the self-inductance capacitive touch display substrate further comprises: a touch electrode layer spaced apart from a layer where the first data line, the second data line and the touch signal line are located; and a passivation layer located between the touch electrode layer and the layer where the first data line, the second data line and the touch signal line are located, wherein
the touch electrode layer comprises a plurality of touch electrode units arranged in an array, and the touch electrode units are connected with the touch signal lines in one-to-one correspondence through via holes in the passivation layer.
